(19) United States
(12) Patent Application Publication
(10) Pub. No.: US 2007/0297517 A1
(43) Pub. Date: Dec. 27, 2007

(54) Entropy encoding and decoding apparatuses, and entropy encoding and decoding methods

(75) Inventors: Daesung Cho, Seoul (KR); Hyun Mun Kim, Seongnam-si (KR); Wooshik Kim, Yongin-si (KR); Dmitri Birinov, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/486,156

(22) Filed: Jul. 14, 2006

(30) Foreign Application Priority Data
Jul. 15, 2005 (KR) 10-2005-0064454

(51) Int. Cl. H04B 1/66

(52) U.S. Cl. 375/240.23; 375/E07.033

(57) ABSTRACT

An entropy encoding apparatus and method. The entropy encoding apparatus includes a estimated CBP value calculating unit which estimates a CBP value of a target block and outputs an estimated CBP value of the target block, and a calculated-CBP value calculating unit which calculates a calculated-CBP value of the target block using an actual CBP value of the target block and the estimated CBP value of the target block. Also provided are an entropy decoding apparatus and method. The entropy decoding apparatus includes an estimated CBP value calculating unit which estimates a CBP value of a target block and outputs the estimated result as a estimated CBP value of the target block, and an actual CBP value calculating unit which calculates an actual CPB value of the target block using the estimated CBP value of the target block and an input calculated-CBP value of the target block.

### CROSS-REFERENCE TO RELATED APPLICATIONS

The present invention relates to image processing, and more particularly, to entropy encoding and decoding apparatuses and entropy encoding and decoding methods included in an image encoding/decoding apparatus and an image encoding/decoding method.

### BACKGROUND OF THE INVENTION

1. Field of the Invention

The present invention relates to image processing, and more particularly, to entropy encoding and decoding apparatuses and entropy encoding and decoding methods included in an image encoding/decoding apparatus and an image encoding/decoding method.

2. Description of the Related Art

Conventional apparatuses and methods for image encoding and decoding convert image data comprised of pixel information having red, green, and blue components into image data with a format appropriate for compression to increase a compression rate. Thereafter, the converted image data is encoded.

The image data with a format appropriate for compression refers to image data in which pixel information is expressed in luma and chroma components.

Moreover, the conventional apparatuses and methods suggest encoding and decoding image data in a 4:2:0 format to further increase the compression rate. The image data in a 4:2:0 format refers to image data in which the size of the chroma components (Cb, and Cr) in the image data is reduced to ¼ the size of the luma components (Y) in the image data.

The Society of Motion Picture and Television Engineers (SMPTE), which is an international standardization organization, has provided the VC-1 standard, a video compression standard (“Proposed SMPTE Standard for Television: VC-1 Compressed Video Bitstream Format and Decoding Process,” SMPTE42M, FCD, 2005).

Methods using the VC-1 standard have excellent compression efficiency. However, chroma components are lost due to sampling when using the encoding and decoding methods. Thus, the encoding and decoding methods are not appropriate for restoring high quality images. Consequently, as the demand for high quality image gradually increases, new apparatuses and methods for encoding and decoding will be required.

### SUMMARY OF THE INVENTION

The present invention provides an entropy encoding apparatus which estimates a CBP value of a target block using CBP values of adjacent blocks, calculates a calculated-CBP value of the target block using the estimated CBP value of the target block and an actual CBP value of the target block, and performs entropy encoding using the calculated results.

The present invention also provides an entropy decoding apparatus which performs entropy decoding by estimating a CBP value of a target block using CBP values of adjacent blocks, and generating an actual CBP value of the target block using the estimated CBP value of the target block and an input calculated-CBP value of the target block.

The present invention also provides an entropy encoding method in which a CBP value of a target block is estimated using CBP values of adjacent blocks, a calculated-CBP value of the target block is calculated using the estimated CBP value of the target block and an actual CBP value of the target block, and entropy encoding is performed using the calculated results.

The present invention also provides an entropy decoding method in which entropy decoding is performed by estimating a CBP value of a target block using CBP values of adjacent blocks, and generating an actual CBP value of the target block using the estimated CBP value of the target block and an input calculated-CBP value of the target block.

The present invention also provides a computer-readable recording medium having recorded thereon an entropy encoding method in which a CBP value of a target block is estimated using CBP values of adjacent blocks, a calculated-CBP value of the target block is calculated using the estimated CBP value of the target block and an actual CBP value of the target block, and entropy encoding is performed using the calculated results.

The present invention also provides a computer-readable recording medium having recorded thereon an entropy decoding method in which entropy decoding is performed by estimating a CBP value of a target block using CBP values of adjacent blocks, and generating an actual CBP value of the target block using the estimated CBP value of the target block and an input calculated-CBP value of the target block.

According to an aspect of the present invention, there is provided an entropy encoding apparatus, including: a estimated CBP value calculating unit which estimates a CBP value of a target block and outputs the estimated result as a estimated CBP value of the target block; and a calculated-CBP value calculating unit which calculates a calculated-CBP value of the target block using an actual CBP value of the target block and the estimated CBP value of the target block, wherein the target block is a block that is currently being entropy encoded, and the prediction is performed in a predetermined image format.

The estimated CBP value calculating unit may include: a comparator which compares a CBP value of a block above the target block and a CBP value of a block to the left of the block above the target block; and a predictor which, in response to the comparison result obtained by the comparator, outputs the CBP value of the block to the left of the target block or the CBP value of the block above the target block as the estimated CBP value of the target block.

The calculated-CBP value of the target block may be the result of performing an XOR operation on the actual CBP value of the target block and the estimated CBP value of the target block.

The target block may be a block of a luma component or a block of a chroma component. The image format may be 4:2:0, 4:2:2, or 4:4:4.

The calculated-CBP value calculating unit may include: a first calculated-CBP value calculator which calculates the calculated-CBP value of a first target block and outputs the calculated result as a first calculated-CBP value of the first target block; and a second calculated-CBP value calculator which calculates the calculated-CBP value of a second target block using the actual CBP value of the first target block having the same phase as a phase of the second target block and the actual CBP value of the second target block, and outputs the calculated result as a second calculated-CBP value of the second target block, wherein the first target block is a block of a luma component or a block of a chroma component, the second target block is a block of a chroma component or a block of a luma component, the image format is 4:4:4, the phase of the first target block indicates a relative location of the first target block in a frame including the first target block, the phase of the second target block indicates a relative location of the second target block in a frame including the second target block.

The second calculated-CBP value calculator may calculate the second calculated-CBP value of the second target block by performing an XOR operation on the actual CBP value of the first target block having the same phase as the phase of the second target block and the actual CBP value of the second target block.

The entropy encoding apparatus may further include a bitstream generating unit which generates a bitstream having the calculated calculated-CBP value of the target block, wherein the generated bitstream is the result of entropy encoding.

According to another aspect of the present invention, there is provided an entropy decoding apparatus, including: a estimated CBP value calculating unit which estimates a CBP value of a target block and outputs the estimated result as a estimated CBP value of the target block; and an actual CBP value calculating unit which calculates an actual CPB value of the target block using the estimated CBP value of the target block and an input calculated-CBP value of the target block, wherein the target block is a block that is currently being decoded, and the prediction is performed in an image format indicated in image format information input together with the calculated-CBP value of the target block.

The estimated CBP value calculating unit may include: a comparator which compares a CBP value of a block above the target block and a CBP value of a block to the left of the block above the target block; and a predictor which, in response to the comparison result obtained by the comparator, outputs the CBP value of the block to the left of the target block or the CBP value of the block above the target block as the estimated CBP value of the target block.

The actual CBP value of the target block may be the result of performing an XOR operation on the estimated CBP value of the target block and the calculated-CBP value of the target block.

The target block may be a block of a luma component or a block of a chroma component. The image format is 4:2:0, 4:2:2, or 4:4:4.

The actual CBP value calculating unit may include: a first actual CBP value calculator which calculates the actual CBP value of a first target block and outputs the calculated result as a first actual CBP value of the first target block; and a second actual CBP value calculator which calculates the actual CBP value of a second target block using the actual CBP value of the first target block having the same phase as a phase of the second target block and the input calculated-CBP value of the second target block, and outputs the calculated result as a second actual CBP value of the second target block, wherein the first target block is a block of a luma component or a block of a chroma component, the second target block is a block of a chroma component or a block of a luma component, the image format is 4:4:4, the phase of the first target block indicates a relative location of the first target block in a frame including the first target block, the phase of the second target block indicates a relative location of the second target block in a frame including the second target block.

The second actual CBP value calculating unit may calculate the second actual CBP value of the second target block by performing an XOR operation on the actual CPB value of the target block having the same phase as the phase of the second target block and the input calculated-CBP value of the second target block.

The entropy decoding apparatus may further include a CBPCY generating unit which generates a bitstream having the actual CBP value of the target block, wherein the generated bitstream is the result of entropy decoding.

According to another aspect of the present invention, there is provided an entropy encoding method, including: estimating a CBP value of a target block and determining the estimated result as a estimated CBP value of the target block; and calculating a calculated-CBP value of the target block using an actual CBP value of the target block and the estimated CBP value of the target block, wherein the target block is a block that is currently being entropy encoded, and the prediction is performed in a predetermined image format.

The estimating of the CBP value of the target block may include: determining whether a CBP value of a block above the target block and a CBP value of a block to the left of the block above the target block are the same; and if it is determined that the CBP value of the block above the target block and the CBP value of the block to the left of the block above the target block are the same, determining the CBP value of the block to the left of the target block to be the estimated CBP value of the target block.

The estimating of the CBP value of the target block may further include: if a CBP value of a block above the target block and a CBP value of a block to the left of the block above the target block are not the same, determining the CBP value of the block above the target block to be the estimated CBP value of the target block.

The calculating of the calculated-CBP value of the target block may include performing an XOR operation on the actual CBP value of the target block and the estimated CBP value of the target block.

The calculating of the calculated-CBP value of the target block may include: calculating the calculated-CBP value of a first target block and determining the calculated result to be a first calculated-CBP value of the first target block; and calculating the calculated-CBP value of a second target block using the actual CBP value of the first target block having the same phase as a phase of the second target block and the actual CBP value of the second target block, and determining the calculated result to be a second calculated-CBP value of the second target block, wherein the first target block is a block of a luma component or a block of a chroma component, the second target block is a block of a chroma component or a block of a luma component, the image format is 4:4:4, the phase of the first target block indicates a relative location of the first target block in a frame including the first target block, the phase of the second target block indicates a relative location of the second target block in a frame including the second target block.

The determining the calculated results to be the second calculated-CBP value may include performing an XOR operation on the actual CBP value of the first target block having the same phase as the phase of the second target block and the actual CBP value of the second target block.

The entropy encoding method may further include generating a bitstream having at least one calculated calculated-CBP value.

According to another aspect of the present invention, there is provided an entropy decoding method, including: estimating a CBP value of a target block and determining the estimated result to be a estimated CBP value of the target block; and calculating an actual CBP value of the target block using the estimated CPB value of the target block and a given calculated-CBP value of the target block, wherein the target block is a block that is currently being decoded, and the prediction is performed in an image format indicated in image format information input together with the calculated-CBP value of the target block.

The estimating of the CBP value of the target block may include: determining whether a CBP value of a block above the target block and a CBP value of a block to the left of the block above the target block are the same; and if it is determined that the CBP value of the block above the target block and the CBP value of the block to the left of the block above the target block are the same, determining the CBP value of the block to the left of the target block to be the estimated CBP value of the target block.

The estimating of the CBP value of the target block may further include: if the CBP value of the block above the target block and the CBP value of the block to the left of the block above the target block are not the same, determining the CBP value of the block above the target block to be the estimated CBP value of the target block.

The calculating of the actual CBP value of the target block may include performing an XOR operation of the estimated CBP value of the target block and the calculated-CBP value of the target block.

The calculating of the actual CBP value of the target block may include: calculating the actual CBP value of a first target block and determining the calculated result to be a first actual CBP value of the first target block; and calculating the actual CBP value of a second target block using the actual CBP value of the first target block having the same phase as a phase of the second target block and the given calculated-CBP value of the second target block, and determining the calculated result to be a second actual CBP value of the second target block, wherein the first target block is a block of a luma component or a block of a chroma component, the second target block is a block of a chroma component or a block of a luma component, the image format is 4:4:4, the phase of the first target block indicates a relative location of the first target block in a frame including the first target block, the phase of the second target block indicates a relative location of the second target block in a frame including the second target block.

The determining the calculated results to be the second actual CBP value may include performing an XOR operation on the actual CBP value of the first target block having the same phase as the phase of the second target block and the given calculated-CBP value of the second target block.

The entropy decoding method may further include generating a bitstream having at least one calculated actual CBP value.

The target block may be a block of a chroma component or a block of a luma component. The image format may be 4:2:0, 4:2:2, or 4:4:4.

According to another aspect of the present invention, there is provided a computer-readable recording medium having recorded thereon a program for executing an entropy encoding method in a computer, the entropy encoding method including: estimating a CBP value of a target block and determining the estimated result as a estimated CBP value of the target block; and calculating a calculated-CBP value of the target block using an actual CBP value of the target block and the estimated CBP value of the target block, wherein the target block is a block that is currently being entropy encoded, and the prediction is performed in a predetermined image format.

According to another aspect of the present invention, there is provided a computer-readable recording medium having recorded thereon a program for executing an entropy decoding method in a computer, the entropy decoding method including: estimating a CBP value of a target block and determining the estimated result to be a estimated CBP value of the target block; and calculating an actual CBP value of the target block using the estimated CPB value of the target block and a given calculated-CBP value of the target block, wherein the target block is a block that is currently being decoded, and the prediction is performed in an image format indicated in image format information input together with the calculated-CBP value of the target block.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of an image encoding and decoding apparatus according to an embodiment of the present invention;

FIG. 2 is a block diagram of an image encoding apparatus including an entropy encoding apparatus according to an embodiment of the present invention;

FIG. 3 is a block diagram of an image decoding apparatus using an entropy decoding apparatus according to an embodiment of the present invention;

FIG. 4A is a view of a macroblock of an image in a 4:2:0 format;

FIG. 4B is a view of a macroblock of an image in a 4:2:2 format;

FIG. 4C is a view of a macroblock of an image in a 4:4:4 format;

FIG. 5 is a block diagram of an entropy encoding apparatus according to an embodiment of the present invention;

FIGS. 6A and 6B are reference diagrams for explaining the principle of generating actual CBP values;

FIG. 7A is a view illustrating a CBPCY (coded block pattern-CY) of a macroblock of an image in a 4:2:0 format;

FIG. 7B is a view illustrating the application of FIG. 7A to FIG. 4A;

FIG. 8 is a diagram for explaining the principle of estimating CBPY values of a macroblock of an image in a 4:2:0 format;

FIG. 9A is a view illustrating a CBPCY of a macroblock of an image in a 4:2:2 format;

FIG. 9B is a view illustrating the application of FIG. 9A to FIG. 4B;

FIGS. 10A and 10B are diagrams for explaining the principle of estimating CBPY values of a macroblock of an image in a 4:2:2 format;

FIG. 11A is a view illustrating a CBPCY of a macroblock of an image in a 4:4:4 format;

FIG. 11B is a view illustrating the application of FIG. 11A to FIG. 4C;

FIG. 12 is a diagram for explaining the principle of estimating CBPY values of a macroblock of an image in a 4:4:4 format;

FIG. 13 is a flow chart illustrating an entropy encoding method according to an embodiment of the present invention;

FIG. 14 is a block diagram of an entropy decoding apparatus according to another embodiment of the present invention; and

FIG. 15 is a flow chart illustrating an entropy decoding method according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

Apparatuses and methods for entropy encoding and decoding of the present invention will now be described more fully with reference to the accompanying drawings, in which exemplary embodiments of the invention are shown. The terminology that follows is defined according to the functions of devices in the present invention and may change according to, for example, conventional usage or the intentions of a user or operator. Therefore, definitions should be derived based on the overall contents of the present application.

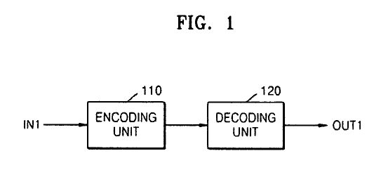

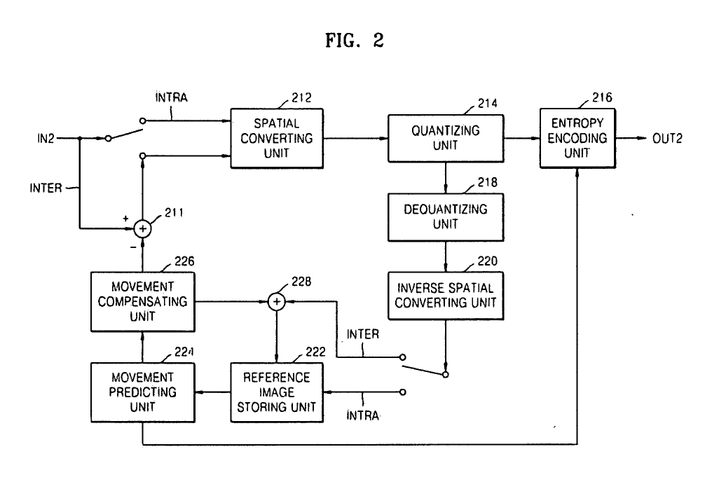

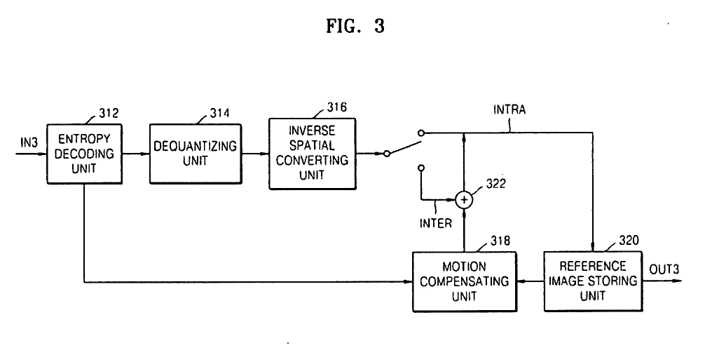

FIG. 1 is a schematic block diagram of an image encoding/decoding apparatus according to an embodiment of the present invention. The image encoding/decoding apparatus includes an encoding unit 110 and a decoding unit 120. The encoding unit 110 compresses and encodes image data, and the decoding unit 120 decodes the compressed and encoded image data, thereby restoring the image data. IN1 denotes the image data input to the encoding unit 110, and OUT1 denotes the image data output by the decoding unit 120. FIG. 1 will be described in more detail with reference to FIGS. 2 and 3.

FIG. 2 is a block diagram of the encoding unit 110 in FIG. 1 according to an embodiment of the present invention. The image encoding apparatus includes a spatial converting unit 212, a quantizing unit 214, an entropy encoding unit 216, a dequantizing unit 218, an inverse spatial converting unit 220, a reference image storing unit 222, a movement estimating unit 224, and a movement compensating unit 226.

The values of the image data may vary with time. Such image data includes information regarding an image, and the image can be displayed.

A previous image refers to an image which was displayed before a current image. Similarly, a subsequent image refers to an image which is displayed after the current image.

IN2 denotes image data input to the image encoding apparatus using the entropy encoding apparatus according to an embodiment of the present invention. That is, IN2 refers to image data that is to be encoded. Hereinafter, IN2 may be called an input image. Here, the input image IN2 may be image data expressed in red (R), green (G), and blue (B) components, or may be image data expressed in luma (Y) and chroma (Cr, and Cb) components.

The image encoding apparatus using the entropy encoding apparatus of the present invention may encode image data according to an inter mode or a intra mode.

Inter mode refers to a mode in which the current image data is encoded by estimating the motion between a frame of previous image data (hereinafter, previous frame) and a frame of the current image data (hereinafter, current frame) in block units.

When encoding in the inter mode, the motion estimating unit 224 and the motion compensating unit 226 are used to predict the motion in the previous restored image. As a result, encoding efficiency may be increased.

Intra mode refers to encoding a block to be currently encoded by considering a method that was used to encode a block spatially adjacent to the block to be currently encoded.

In the inter mode, data input to the spatial converting unit 212 is a estimated residue value. Here, a residue value refers to an error between the input image IN2 and an image estimated by the motion estimating unit 224 based on a previous reference image stored in the reference image storing unit 222 and compensated in the motion compensating unit 226.

In the intra mode, data input to the spatial converting unit 212 is the input image IN2 itself.

The spatial converting unit 212 converts the input data IN2 into block units using discrete cosine transform (DCT) or the like. The quantizing unit 214 quantizes the data converted into the block units and generates quantization coefficients.

In the inter mode, the generated quantization coefficients are used for motion prediction in a frame of subsequent image data (hereinafter, subsequent frame). To this end, the dequantizing unit 218 dequantizes the generated quantization coefficients, and the inverse spatial converting unit 220 performs IDCT (inverse discrete cosine transform) on the results of dequantization, thereby restoring the data input to the spatial converting unit 212. In this case, an adding unit 228 adds the data restored by the inverse spatial converting unit 220 and the data compensated and generated by the motion compensating unit 226. In the inter mode, the added result forms a reference image, and the reference image storing unit 222 stores the added result as the reference image.

However, in the intra mode, the data restored by the inverse spatial converting unit 220 becomes a reference image. Accordingly, the reference image storing unit 222 stores the restored data as the reference image.

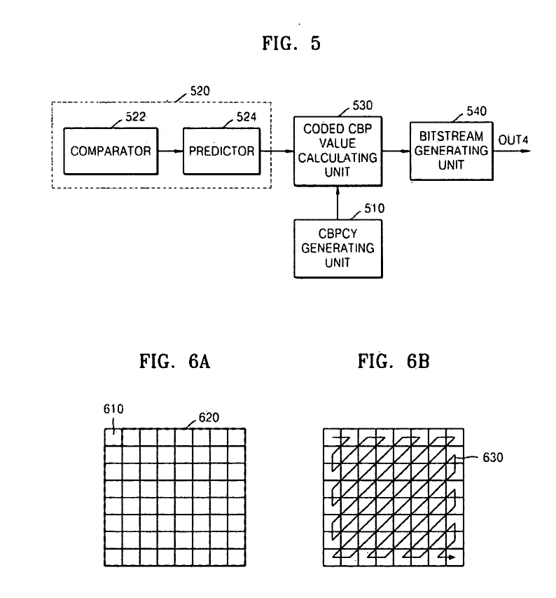

The entropy encoding unit 216 entropy encodes the quantization coefficients, and generates a bitstream having the encoded results. OUT2 refers to the bitstream. The entropy encoding apparatus according to the present embodiment provides a new encoding method performed by the entropy encoding unit 216, and this will be described in more detail with reference to FIGS. 5 through 13 later.

FIG. 3 is a block diagram of an image decoding apparatus using an entropy decoding apparatus according to an embodiment of the present invention. The image decoding apparatus includes an entropy decoding unit 312, a dequantizing unit 314, an inverse spatial converting unit 316, a motion compensating unit 318, and a reference image storing unit 320.

IN3 denotes the result of encoding by the entropy encoding apparatus according to the present embodiment. That is, IN3 may be the bitstream OUT2. Here, IN3 may be compressed data.

The entropy decoding unit 312 decodes the bitstream OUT2 to restore the quantizied coefficients. The dequantizing unit 314 dequantizes the quantized coefficients, and the inverse spatial converting unit 316 performs IDCT on the dequantized results. As a result, the data input to the spatial converting unit 212 is restored.

In the intra mode, the data restored by the inverse spatial converting unit 316 is stored in the reference image storing unit 320 as a reference image.

However, in the inter mode, an adder 322 adds the data restored by the inverse spatial converting unit 316 and a estimated image compensated by the motion compensating unit 318. In this case, the reference image storing unit 320 stores the added results as a reference image.

OUT3 is the result of image restoration, that is, the restored image. In more detail, the restored image refers to data restored by the inverse spatial converting unit 316 when in the intra mode, and the restored image refers to the result of adding by the adder 322 when in the inter mode.

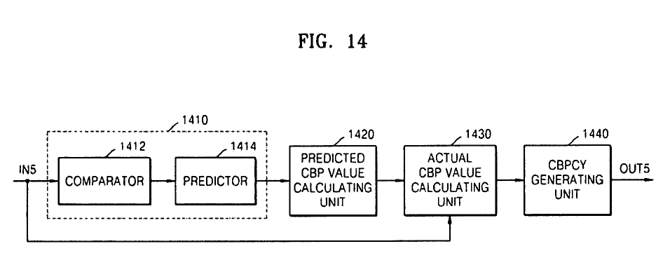

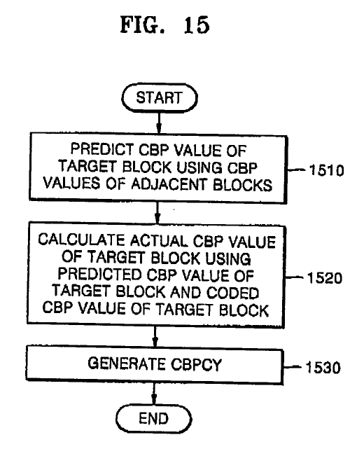

The entropy decoding apparatus according to an embodiment of the present invention provides a new decoding method performed by the entropy decoding unit 312. This will be described in more detail with reference to FIGS. 14 and 15 later.

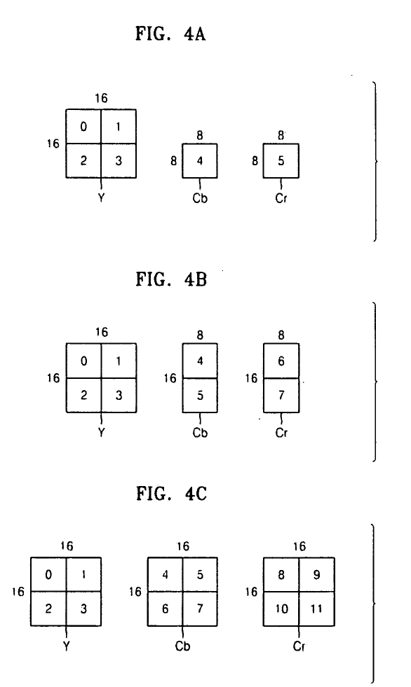

FIG. 4A is a view of a macroblock of an image in a 4:2:0 format, FIG. 4B is a view of a macroblock of an image in a 4:2:2 format, and FIG. 4C is a view of a macroblock of an image in a 4:4:4 format.

In the image encoding apparatus and method using the entropy encoding apparatus and entropy encoding method, the input image data is divided into blocks having predetermined sizes, and encoding is performed in block units.

Similarly, in the image decoding apparatus and method using the entropy decoding apparatus and entropy decoding method, the encoded data is divided into bocks having predetermined sizes, and decoding is performed in block units.

Consequently, the basic unit of encoding and/or decoding is the block.

The macroblocks used in the entropy encoding and decoding apparatus and the entropy encoding and decoding method comprised luma (Y) component blocks and chroma (Cb or Cr) component blocks. In more detail, in a macroblock of a 4:2:0 format image, a luma (Y) component block is a 16×16 block having 256 pixels, and a chroma (Cb or Cr) component block is an 8×8 block having 64 pixels.

In a macroblock of a 4:2:2 format image, a luma component block is a 16×16 block having 256 pixels, and a chroma component block is an 8×16 block having 128 pixels.

In a macroblock of a 4:4:4 format image, a luma component block is a 16×16 block having 256 pixels, and a chroma component block is a 16×16 having 256 pixels.

Here, the size of the block is proportional to the resolution of an image displayed by the block. Also, the types of images having the above-mentioned formats are described for convenience of explanation, and the present invention is not limited thereto. Moreover, the size of the unit blocks, which are the smallest units making up the macroblocks, are 8×8, which is suggested for convenience of explanation, and the present invention is not limited thereto.

In the entropy encoding apparatus and method of the present invention, encoding may be performed in the order indicated by the numbers marked in the blocks. Similarly, in the entropy decoding apparatus and method, decoding may be performed in the order indicated by the numbers marked in the blocks.

Meanwhile, to achieve high resolution in an application requiring high quality image restoration, the block size of the chroma (Cb or Cr) component may be the same as that of the luma (Y) component. That is, an image expressed in a 4:4:4 format provides a higher quality image than an image expressed in a 4:2:0 format.

The entropy encoding and decoding apparatuses and the entropy encoding and decoding methods according to embodiments of the present invention provide efficient compression technology for a macroblock of an image in a 4:2:0 format in addition to a macroblock of an image in a 4:4:4 format.

FIG. 5 is a block diagram of an entropy encoding apparatus according to an embodiment of the present invention. The entropy encoding apparatus includes a coded block pattern (CBP) CY generating unit 510, a estimated CBP value calculating unit 520, a calculated-CBP value calculating unit 530, and a bitstream generating unit 540. The estimated CBP value calculating unit 520 may include a comparator 522 and a predictor 524 as illustrated in FIG. 5.

The CBPCY generating unit 510 generates CBPCY. The CBP is a pattern of bits indicating whether a coefficient other than 0 exists in quantization coefficients generated by the quantization unit 214. The bit is generated every block. “C” in CY denotes chroma (Cb or Cr), and “Y” denotes luma (Y). In other words, CBPCY denotes a pattern having both a luma component CBP value and a chroma component CBP value.

The operating principle of the CBPCY generating unit 510 will be described in more detail with reference to FIGS. 6A and 6B as an example. FIGS. 6A and 6B are reference diagrams for explaining the principle of generating actual CBP values. In more detail, FIG. 6A is a view illustrating quantization coefficients of an 8×8 block generated by the quantization unit 214, and FIG. 6B is a view for explaining zigzag scanning of the quantization coefficients. Here, the size of 8×8 is suggested for the convenience of explanation, and the present invention is not limited thereto.

The quantization coefficients are provided in 64 pixels illustrated in FIGS. 6A and 6B. The quantization coefficients include a DC coefficient 610 and AC coefficients 620. The AC coefficient refers to a coefficient provided in any one of the block included in reference number 620.

The CBPCY generating unit 510 scans the 64 pixels in a zigzag pattern as illustrated in FIG. 6B, and encodes the 64 pixels into one bit indicating whether there is a coefficient other than 0 among the 64 quantization coefficients. The generated bit is CBP, and its value is a CBP value. The CBP value may be 0 or 1.

In more detail, in the inter mode, the CBPCY generating unit 510 determines a CBP value according to whether a coefficient other than 0 exists among coefficient values in the unit block (8×8 block), regardless of whether the coefficient other than 0 is a DC coefficient or an AC coefficient. That is, if a coefficient other than 0 exists, the CBP value is set to 1, and if all of the 64 quantization coefficients are 0, the CBP value is set to 0.

In the intra mode, the CBPCY generating unit 510 determines a CBP value according to whether a coefficient other than 0 exists among 63 AC coefficients, regardless of the DC coefficient. That is, if an AC coefficient other than 0 exists, the CBP value is set to 1, and if all of the 63 AC coefficients are 0, the CBP value is set to 0.

The estimated CBP value calculating unit 520 estimates a CBP value of a target block, and outputs the estimated results as a estimated CBP value of the target block. The calculated-CBP value calculating unit 530 calculates a calculated-CBP value of the target block using an actual CBP value of the target block and the estimated CBP value of the target block.

Here, the target block is a block that is to be currently entropy encoded. In other words, the target block may refer to a macroblock itself that is currently being encoded, a luma (Y) component block included in the macroblock that is currently being encoded, or a chroma (Cb or Cr) component block included in the macroblock that is currently being encoded.

The estimation may be performed using a predetermined image format. Examples of the image format include the 4:2:0, 4:2:2, and 4:4:4 image formats.

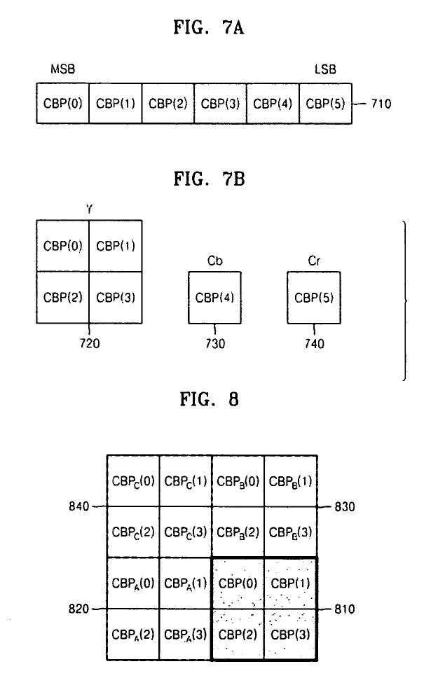

The detailed operating principle of the estimated CBP value calculating unit 520 and the calculated-CBP value calculating unit 530 will be described with reference to FIGS. 7 through 12.

The estimated CBP value calculating unit 520 may include the comparator 522 and the predictor 524, as illustrated in FIG. 6. The comparator 522 compares a CBP value of a block above the target block and a CBP value of a block to the upper left of the target block. In response to the compared results of the comparator 522, the predictor 524 outputs a CBP value of a block to the left of the target block or the CBP value of the block above the target block as a estimated CBP value of the target block.

The use of the CBP value of the block above the target block and the CBP value of the block to the upper left of the block is suggested as an example of the object of comparison by the comparator is based on to the encoding order illustrated in FIG. 4.

FIG. 7A is a view illustrating a CBPCY 710 of a macroblock of an image in a 4:2:0 format. FIG. 7B is a view illustrating the application of FIG. 7A to FIG. 4A.

CBP(0) through CBP(3) denote CBP values of target blocks 720 of a luma (Y) component, CBP(4) denotes a CBP value of a target block 730 of a chroma (Cb) component, and CBP (5) denotes a CBP value of a target block 740 of a chroma (Cr) component.

Consequently, the CBPCY 710 is composed of 6 bits, and may have a value from 0 through 63. In addition, the CBP(0) is a most significant bit (MSB) in the CBPCY 710, and denotes a CBP value of a first target block (i.e., an upper left block among the four target blocks 720) of the luma (Y) component. Similarly, the CBP(5) is a least significant bit (LSB) of the CBPCY 710, and denotes a CBP value of the last target block 740 of the luma components (Cb and Cr).

FIG. 8 is a diagram for explaining the principle of estimating CBPY values of a macroblock of an image in the 4:2:0 format. CBP values (CBP(0) through CBP(3)) of target blocks 810 are estimated and determined as follows by the estimated CBP value calculating unit 520. Here, reference numbers 820 through 840 represent blocks adjacent to the target blocks 810.

The estimated CBP value calculating unit 520 respectively estimates using the following equations, and the calculated-CBP value calculating unit 530 respectively calculates CBP(0) through CBP(3) using the following equations.

$${CBP}_{p} ( 0 ) = \{ \begin{matrix}{CBP}_{A} ( 1 ) , if {CBP}_{B} ( 2 ) ⩵ {CBP}_{C} ( 3 ) \\ {CBP}_{B} ( 2 ) , otherwise\end{matrix} \\ CBP ( 0 ) = {CBP}_{p} ( 0 ) \hat{} ( ( CBPCY >> 5 ) \& 0 x 01 ) \\ {CBP}_{p} ( 1 ) = \{ \begin{matrix}CBP ( 0 ) , if {CBP}_{B} ( 3 ) ⩵ {CBP}_{B} ( 2 ) \\ {CBP}_{B} ( 3 ) , otherwise\end{matrix} \\ CBP ( 1 ) = {CBP}_{p} ( 1 ) \hat{} ( ( CBPCY >> 4 ) \& 0 x 01 ) \\ {CBP}_{p} ( 2 ) = \{ \begin{matrix}{CBP}_{A} ( 3 ) , if CBP ( 0 ) ⩵ {CBP}_{A} ( 1 ) \\ CBP ( 0 ) , otherwise\end{matrix} \\ CBP ( 2 ) = {CBP}_{p} ( 2 ) \hat{} ( ( CBPCY >> 3 ) \& 0 x 01 ) \\ {CBP}_{p} ( 3 ) = \{ \begin{matrix}CBP ( 2 ) , if CBP ( 1 ) ⩵ CBP ( 0 ) \\ CBP ( 1 ) , otherwise\end{matrix} \\ CBP ( 3 ) = {CBP}_{p} ( 3 ) \hat{} ( ( CBPCY >> 2 ) \& 0 x 01 ) \qquad ( 1 )$$

Here, the subscript P denotes prediction. That is, CBP_{P} denotes a estimated CBP value. For example, the comparator 522 compares a CBP value (CBP_{B}(2)) of a block above the CBP(0) locating target block and a CBP value (CBP_{C}(3)) of a block to the upper left of the CBP(0) locating target block to determine the estimated CBP value CBP_{P}(0). Then, the predictor 524 responds to the comparison results and determines a CBP value (CBP_{A}(1)) of a block to the left of the CBP(0) or the CBP value (CBP_{B}(2)) of the block above the CBP(0) as a estimated CBP value (CBP_{P}(0)). In this way, the estimated CBP value calculating unit 520 may calculate the estimated CBP value (CBP_{P}(0)).

Meanwhile, the calculated-CBP value calculating unit 530 performs an XOR operation on an actual CBP value of a target block and the calculated estimated CBP value of the target block to calculate a calculated-CBP value block. Here, XOR is used to achieve higher compression rate than when directly encoding the actual CBP value.

Consequently, the calculated-CBP value calculating unit 530 performs an XOR operation on the estimated CBP value (CBP_{P}(0)) and the actual CBP value ((CBPCY>>5)&0×01) to calculate the calculated-CBP value (CBP(0)). Here, “(CBPCY>>5)&0×01” denotes the 5^{th} bit value from the LSB towards the MSB of the CBPCY 710 illustrated in FIG. 7. A in Equation 1 denotes XOR.

The CBP(1) through CBP(5) in FIG. 7 can be calculated using the process for calculating the CBP(0). When calculating the calculated-CBP values (CBP(4) and CBP(5)) of the chroma component in an image in a 4:2:0 format as illustrated in FIGS. 7 and 8, an actual CBP value may be set as a calculated-CBP value, unlike when calculating the calculated-CBP values (CBP(0) through CBP(3) of the luma component. That is, CBP(4)=(CBPCY>>1)&0×01 and CBP(5)=(CBPCY>>0)&0×01).

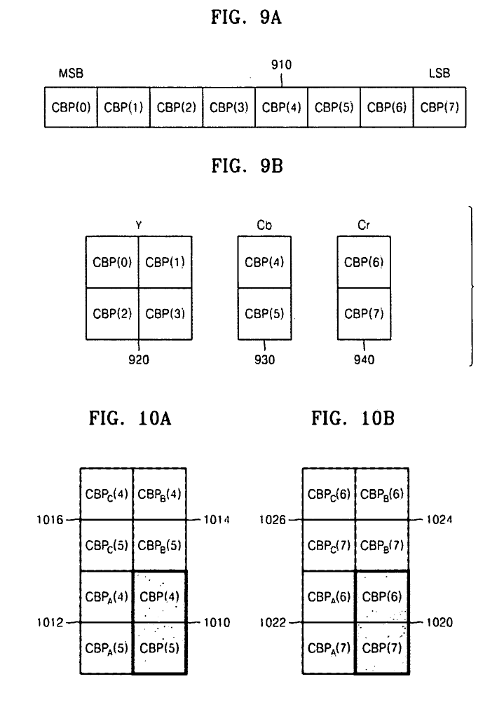

FIG. 9A is a view illustrating a CBPCY 910 of a macroblock of an image in a 4:2:2 format, and FIG. 9B is a view illustrating the application of FIG. 9A to FIG. 4B.

CBP(0) through CBP(3) denote CBP values of target blocks 920 of a luma (Y) component, CBP(4) and CBP (5) denote CBP values of target blocks 930 of a chroma (Cb) component, and CBP (6) and CBP(7) denote CBP values of target blocks 940 of a chroma (Cr) component.

Consequently, the CBPCY 910 is composed of 8 bits, and may have a value from 0 through 255. In addition, the CBP(0) is a most significant bit (MSB) in the CBPCY 910, and denotes a CBP value of a first target block (i.e., an upper left block among the four target blocks 920) of the luma (Y) component. Similarly, the CBP(7) is a least significant bit (LSB) in the CBPCY 910, and denotes a CBP value of the last target block 940 of the luma components (Cb and Cr).

FIGS. 10A and 10B are diagrams for explaining the principle of estimating CBPY values of a macroblock of an image in the 4:2:2 format. CBP values (CBP(4) through CBP(7)) of target blocks 1010 or 1020 are estimated and determined as follows by the estimated CBP value calculating unit 520. Here, reference numbers 1012 through 1016 and 1022 through 1026 denote blocks adjacent to the target blocks 1010 through 1020.

The estimated CBP value calculating unit 520 respectively estimates CBPₚ(0) through CBPₚ(3) using the following equations, and the calculated-CBP value calculating unit 530 respectively calculates CBP(0) through CBP(3) using the following equations.

Although not illustrated in FIGS. 10A and 10B, CBP values (CBP(0) through CBP(3)) of the luma component are also calculated, and the principle for the calculation is the same as the principle described with reference to FIGS. 7 and 8.

$${CBP}_{p} ( 0 ) = \{ \begin{matrix}{CBP}_{A} ( 1 ) , if {CBP}_{B} ( 2 ) ⩵ {CBP}_{C} ( 3 ) \\ {CBP}_{B} ( 2 ) , otherwise\end{matrix} \\ CBP ( 0 ) = {CBP}_{p} ( 0 ) \hat{} ( ( CBPCY >> 7 ) \& 0 x 01 ) \\ {CBP}_{p} ( 1 ) = \{ \begin{matrix}CBP ( 0 ) , if {CBP}_{B} ( 3 ) ⩵ {CBP}_{B} ( 2 ) \\ {CBP}_{B} ( 3 ) , otherwise\end{matrix} \\ CBP ( 1 ) = {CBP}_{p} ( 1 ) \hat{} ( ( CBPCY >> 6 ) \& 0 x 01 ) \\ {CBP}_{p} ( 2 ) = \{ \begin{matrix}{CBP}_{A} ( 3 ) , if CBP ( 0 ) ⩵ {CBP}_{A} ( 1 ) \\ CBP ( 0 ) , otherwise\end{matrix} \\ CBP ( 2 ) = {CBP}_{p} ( 2 ) \hat{} ( ( CBPCY >> 5 ) \& 0 x 01 ) \\ {CBP}_{p} ( 3 ) = \{ \begin{matrix}CBP ( 2 ) , if CBP ( 1 ) ⩵ CBP ( 0 ) \\ CBP ( 1 ) , otherwise\end{matrix} \\ CBP ( 3 ) = {CBP}_{p} ( 3 ) \hat{} ( ( CBPCY >> 4 ) \& 0 x 01 ) \qquad ( 2 )$$

Moreover, the estimated CBP value calculating unit 520 respectively estimates CBPₚ(4) through CBPₚ(7) using the following equations, and the calculated-CBP value calculating unit 530 respectively calculates the CBP(4) through CBP(7) using the following calculations.

$${CBP}_{p} ( 4 ) = \{ \begin{matrix}{CBP}_{A} ( 4 ) , if {CBP}_{B} ( 5 ) ⩵ {CBP}_{B} ( 5 ) \\ {CBP}_{B} ( 5 ) , otherwise\end{matrix} \\ CBP ( 4 ) = {CBP}_{p} ( 4 ) \hat{} ( ( CBPCY >> 3 ) \& 0 x 01 ) \\ {CBP}_{p} ( 5 ) = \{ \begin{matrix}{CBP}_{A} ( 5 ) , if CBP ( 4 ) ⩵ {CBP}_{A} ( 4 ) \\ {CBP}_{A} ( 4 ) , otherwise\end{matrix} \\ CBP ( 5 ) = {CBP}_{p} ( 5 ) \hat{} ( ( CBPCY >> 2 ) \& 0 x 01 ) \\ {CBP}_{p} ( 6 ) = \{ \begin{matrix}{CBP}_{A} ( 6 ) , if {CBP}_{B} ( 7 ) ⩵ {CBP}_{C} ( 7 ) \\ {CBP}_{B} ( 7 ) , otherwise\end{matrix} \\ CBP ( 6 ) = {CBP}_{p} ( 6 ) \hat{} ( ( CBPCY >> 1 ) \& 0 x 01 ) \\ {CBP}_{p} ( 7 ) = \{ \begin{matrix}{CBP}_{A} ( 7 ) , if CBP ( 6 ) ⩵ {CBP}_{A} ( 6 ) \\ CBP ( 6 ) , otherwise\end{matrix} \\ CBP ( 7 ) = {CBP}_{p} ( 7 ) \hat{} ( CBPCY \& 0 x 01 ) \qquad ( 3 )$$

The principle of calculating CBP(4) through CBP(7) is the same as the principle described with reference to FIGS. 7 and 8. That is, the subscript P denotes prediction and CBP_{P} denotes a estimated CBP value. For example, the comparator 522 compares a CBP value (CBP_{B}(5)) of a block above the CBP(4) locating target block and a CBP value (CBP_{C}(5)) of a block to the upper left of the CBP(4) locating target block to determine CBP_{P}(4). Then, in response to the comparison result, the predictor 524 determines a CBP value (CBP_{A}(4)) of a block to the left of the CBP(4) or the CBP value (CBP_{B}(5)) of the block above CBP(4) as a estimated CBP value (CBP_{P}(4)). In this way, the estimated CBP value calculating unit 520 may calculate the estimated CBP value (CBP_{P}(4)).

The calculated-CBP value calculating unit 530 performs an XOR operation on the estimated CBP value (CBP_{P}(4)) and an actual CBP value ((CBPCY>>3)&0×01) to calculate a calculated-CBP value CBP(4). Here, (CBPCY>>3)&0×01 denotes the 3^{rd} bit value from the LSB towards the MSB of the CBPCY 910 illustrated in FIG. 9. A in Equations 2 and 3 denotes XOR.

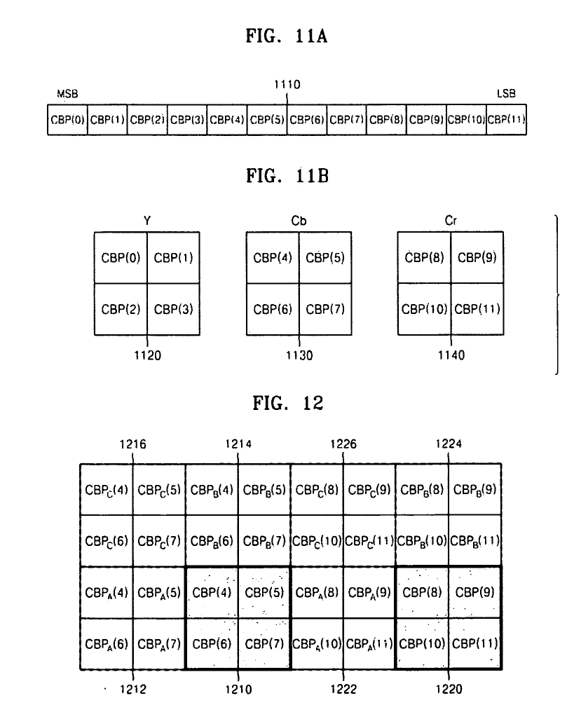

FIG. 11A is a view illustrating a CBPCY 1110 of a macroblock of an image in the 4:4:4 format, and FIG. 11B is a view illustrating the application of FIG. 11A to FIG. 4C.

CBP(0) through CBP(3) denote CBP values of target blocks 1120 of a luma (Y) component, CBP(4) through CBP (7) denote CBP values of target blocks 1130 of a chroma (Cb) component, and CBP (8) and CBP(11) denote CBP values of target blocks 1140 of a chroma (Cr) component.

Consequently, the CBPCY 1110 is composed of 12 bits, and may have a value from 0 through 4095. In addition, the CBP(0) is a most significant bit (MSB) in the CBPCY 1110, and denotes a CBP value of a first target block (i.e., an upper left block among the four target blocks 1120) of the luma (Y) component in the CBPCY 1110. Similarly, the CBP(11) is a least significant bit (LSB) in the CBPCY 1110, and denotes a CBP value of the last target block (i.e., a lower right block among the four target blocks 1140) of the luma components (Cb and Cr).

FIG. 12 is a diagram for explaining the principle of estimating CBPY values of a macroblock of an image in the 4:4:4 format. CBP values (CBP(4) through CBP(11)) of target blocks 1210 or 1220 are estimated and determined as follows by the estimated CBP value calculating unit 520. Reference numbers 1212 through 1216 and 1222 through 1226 are blocks adjacent to the target blocks 1210 through 1220.

The estimated CBP value calculating unit 520 respectively estimates CBP_{P}(0) through CBP_{P}(3) using the following equations, and the calculated-CBP value calculating unit 530 respectively calculates CBP(0) through CBP(3) using the following equations.

Although not illustrated in FIG. 12, CBP values CBP(0) through CBP(3) of a luma component are also calculated, and the principle for doing so is the same as the principle described with reference to FIGS. 7 and 8.

$${CBP}_{p} ( 0 ) = \{ \begin{matrix}{CBP}_{A} ( 1 ) , if {CBP}_{B} ( 2 ) ⩵ {CBP}_{C} ( 3 ) \\ {CBP}_{B} ( 2 ) , otherwise\end{matrix} \\ CBP ( 0 ) = {CBP}_{p} ( 0 ) \hat{} ( ( CBPCY >> 11 ) \& 0 x 01 ) \\ {CBP}_{p} ( 1 ) = \{ \begin{matrix}CBP ( 0 ) , if {CBP}_{B} ( 3 ) ⩵ {CBP}_{B} ( 2 ) \\ {CBP}_{B} ( 3 ) , otherwise\end{matrix} \\ CBP ( 1 ) = {CBP}_{p} ( 1 ) \hat{} ( ( CBPCY >> 10 ) \& 0 x 01 ) \\ {CBP}_{p} ( 2 ) = \{ \begin{matrix}{CBP}_{A} ( 3 ) , if CBP ( 0 ) ⩵ {CBP}_{A} ( 1 ) \\ CBP ( 0 ) , otherwise\end{matrix} \\ CBP ( 2 ) = {CBP}_{p} ( 2 ) \hat{} ( ( CBPCY >> 9 ) \& 0 x 01 ) \\ {CBP}_{p} ( 3 ) = \{ \begin{matrix}CBP ( 2 ) , if CBP ( 1 ) ⩵ CBP ( 0 ) \\ CBP ( 1 ) , otherwise\end{matrix} \\ CBP ( 3 ) = {CBP}_{p} ( 3 ) \hat{} ( ( CBPCY >> 8 ) \& 0 x 01 ) \qquad ( 4 )$$

Moreover, the estimated CBP value calculating unit 520 respectively estimates CBP_{P}(4) through CBP_{P}(11) using the following equations, and the calculated-CBP value calculating unit 530 respectively calculates CBP(4) through CBP(11) using the following equations.

$${CBP}_{p} ( 4 ) = \{ \begin{matrix}{CBP}_{A} ( 5 ) , if {CBP}_{B} ( 6 ) ⩵ {CBP}_{C} ( 7 ) \\ {CBP}_{B} ( 6 ) , otherwise\end{matrix} \\ CBP ( 4 ) = {CBP}_{p} ( 4 ) \hat{} ( ( CBPCY >> 7 ) \& 0 x 01 ) \\ {CBP}_{p} ( 5 ) = \{ \begin{matrix}CBP ( 4 ) , if {CBP}_{B} ( 7 ) ⩵ {CBP}_{B} ( 6 ) \\ {CBP}_{B} ( 7 ) , otherwise\end{matrix} \\ CBP ( 5 ) = {CBP}_{p} ( 5 ) \hat{} ( ( CBPCY >> 6 ) \& 0 x 01 ) \\ {CBP}_{p} ( 6 ) = \{ \begin{matrix}{CBP}_{A} ( 7 ) , if CBP ( 4 ) ⩵ {CBP}_{A} ( 5 ) \\ CBP ( 4 ) , otherwise\end{matrix} \\ CBP ( 6 ) = {CBP}_{p} ( 6 ) \hat{} ( ( CBPCY >> 5 ) \& 0 x 01 ) \\ {CBP}_{p} ( 7 ) = \{ \begin{matrix}CBP ( 6 ) , if CBP ( 5 ) ⩵ CBP ( 4 ) \\ CBP ( 5 ) , otherwise\end{matrix} \\ CBP ( 7 ) = {CBP}_{p} ( 7 ) \hat{} ( ( CBPCY >> 4 ) \& 0 x 01 ) \\ {CBP}_{p} ( 8 ) = \{ \begin{matrix}{CBP}_{A} ( 9 ) , if {CBP}_{B} ( 10 ) ⩵ {CBP}_{C} ( 11 ) \\ {CBP}_{B} ( 10 ) , otherwise\end{matrix} \\ CBP ( 8 ) = {CBP}_{p} ( 8 ) \hat{} ( ( CBPCY >> 3 ) \& 0 x 01 ) \\ {CBP}_{p} ( 9 ) = \{ \begin{matrix}CBP ( 8 ) , if {CBP}_{B} ( 11 ) ⩵ {CBP}_{B} ( 10 ) \\ {CBP}_{B} ( 11 ) , otherwise\end{matrix} \\ CBP ( 9 ) = {CBP}_{p} ( 9 ) \hat{} ( ( CBPCY >> 2 ) \& 0 x 01 ) \\ {CBP}_{p} ( 10 ) = \{ \begin{matrix}{CBP}_{A} ( 11 ) , if CBP ( 8 ) ⩵ {CBP}_{A} ( 9 ) \\ CBP ( 8 ) , otherwise\end{matrix} \\ CBP ( 10 ) = {CBP}_{p} ( 10 ) \hat{} ( ( CBPCY >> 1 ) \& 0 x 01 ) \\ {CBP}_{p} ( 11 ) = \{ \begin{matrix}CBP ( 10 ) , if CBP ( 9 ) ⩵ CBP ( 8 ) \\ CBP ( 9 ) , otherwise\end{matrix} \\ CBP ( 11 ) = {CBP}_{p} ( 11 ) \hat{} ( CBPCY ) \& 0 x 01 ) \qquad ( 5 )$$

The principle for calculating CBP(4) through CBP(11) is the same as the principle described with reference to FIGS. 7 and 8. That is, the subscript P denotes prediction and CBP_{P} denotes a estimated CBP value. For example, the comparator 522 compares a CBP value (CBP_{B}(6)) of a block above the CBP(4) of the target block and a CBP value (CBP_{C}(7)) of a block to the upper left of the CBP(4) of the target block to determine CBP_{P}(4). Then, in response to the compared results, the predictor 524 determines a CBP value (CBP_{A}(5)) of a block to the left of the CBP(4) or the CBP value (CBP_{B}(6)) of the block above the CBP(4) as a estimated CBP value (CBP_{P}(4)). In this way, the estimated CBP value calculating unit 520 can calculate the estimated CBP value (CBP_{P}(4)).

Consequently, the calculated-CBP value calculating unit 530 performs an XOR operation on the estimated CBP value (CBP_{P}(4)) and an actual CBP value ((CBPCY>>7)&0×01) to calculate a calculated-CBP value CBP(4). Here, (CBPCY>>7)&0×01 denotes the 7^{th} bit value from the LSB towards the MSB of the CBPCY1110 illustrated in FIG. 11. A in Equations 4 and 5 denotes XOR.

When entropy encoding an image in the 4:4:4 format as illustrated in FIGS. 11 and 12, after calculating a calculated-CBP value of a luma component (or a chroma component), a calculated-CBP value of a chroma component (or a luma component) can be calculated using the calculated calculated-CBP value of the luma component (or the chroma component).

In other words, the calculated-CBP value of the chroma component (or the luma component) of a target block can be calculated using an actual CBP value of the chroma component (or the luma component) of the target block and a estimated CBP value of the chroma component (or the luma component) of the target block. However, the calculated-CBP value of the chroma component (or the luma component) of a target block can be calculated using an actual CBP value of the already calculated luma component (or the chroma component) of the target block and an actual CBP value of the chroma component (or the luma component) of the target block.

In this case, the calculated-CBP value calculating unit 530 may include a first calculated-CBP value calculator (not shown) and a second calculated-CBP value calculator (not shown).

The first calculated-CBP value calculator calculates a calculated-CBP value of a first target block (one of the blocks included in a block 1120) and outputs the calculated result as a first calculated-CBP value of the first target block. The second calculated-CBP value calculator calculates a calculated-CBP value of a second target block using an actual CBP value of a first target block (one of the blocks included in a block 1130 or one of the blocks included in a block 1140) having the same phase as a phase of the second target block and an actual CBP value of the second target block. Then, the second calculated-CBP value calculator outputs the calculated results as a second calculated-CBP value of the second target block.

The first target block (one of the blocks included in the block 1120) is a block of a chroma component or a block of a luma component, and the second target block (one of the blocks included in the block 1130 or one of the blocks included in the block 1140) is a block of a chroma component.

Meanwhile, the phase of the first target block may indicate a relative location of the first target block in a frame (a frame having target blocks in the block 1120) in which the first target block is included. The phase of the second target block may indicate a relative location of the second target block in a frame (a frame having target blocks in the block 1130 or a frame having target blocks in the block 1140) in which the second target block is included.

Furthermore, the second calculated-CBP value calculator can perform an XOR operation on the actual CBP value of the first target block having the same phase as the phase of the second target block and the actual CBP value of the second target block, and output the XOR operation result as the second calculated-CBP value of the second target block.

Such an encoding principle can be expressed in the following equations.

$$CBP ( 4 ) = CBP ( 0 ) \hat{} ( ( CBPCY >> 7 ) \& 0 x 01 ) \\ CBP ( 5 ) = CBP ( 1 ) \hat{} ( ( CBPCY >> 6 ) \& 0 x 01 ) \\ CBP ( 6 ) = CBP ( 2 ) \hat{} ( ( CBPCY >> 5 ) \& 0 x 01 ) \\ CBP ( 7 ) = CBP ( 3 ) \hat{} ( ( CBPCY >> 4 ) \& 0 x 01 ) \\ CBP ( 8 ) = CBP ( 0 ) \hat{} ( ( CBPCY >> 3 ) \& 0 x 01 ) \\ CBP ( 9 ) = CBP ( 1 ) \hat{} ( ( CBPCY >> 2 ) \& 0 x 01 ) \\ CBP ( 10 ) = CBP ( 2 ) \hat{} ( ( CBPCY >> 1 ) \& 0 x 01 ) \\ CBP ( 11 ) = CBP ( 3 ) \hat{} ( CBPCY \& 0 x 01 ) \qquad ( 6 )$$

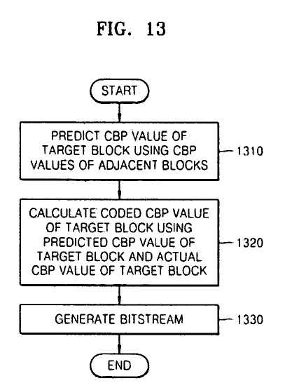

FIG. 13 is a flow chart illustrating an entropy encoding method according to an embodiment of the present invention. The method includes estimating a CBP value of a target block, calculating a calculated-CBP value of the target block using the estimated CBP value of the target block and an actual CBP value of the target block (operations 1310 and 1320), and generating bit streams having the calculated-CBP values (operation 1330).

The estimated CBP value calculating unit 520 calculates a estimated CBP value of the target block using CBP values of adjacent blocks (operation 1310). The calculated-CBP value calculating unit 530 calculates a calculated-CBP value of the target block using an actual CBP value of the target block and the calculated estimated CBP value of the target block (operation 1320). After operation 1320, the bitstream generating unit 540 generates a bitstream having the calculated-CBP values (operation 1330).

FIG. 14 is a block diagram of an entropy decoding apparatus according to another embodiment of the present invention. The entropy decoding apparatus includes an analyzing unit 1410, a estimated CBP value calculating unit 1420, an actual CBP value calculating unit 1430, and a CBPCY generating unit 1440. In FIG. 14, IN5 denotes the encoded results generated by an entropy encoding apparatus according to an embodiment of the present invention, and may be a bitstream OUT4. Meanwhile, OUT5 denotes decalculated-CBPCY.

One objective of the entropy decoding apparatus is to accurately restore and obtain a CBPCY which has been entropy encoded by the entropy encoding apparatus according to an embodiment of the present invention.

The following is a detailed description of the entropy decoding apparatus of the present invention. The analyzing unit 1410 analyzes the bitstream IN5 and obtains a calculated-CBP value of a target block from the bitstream IN5.

The estimated CBP value calculating unit 1420 estimates a CBP value of a target block and outputs the estimated results as a estimated CBP value. The actual CBP value calculating unit 1430 calculates an actual CBP value of the target block using the output estimated CBP value of the target block and the input calculated-CBP value of the target block. The input calculated-CBP value of the target block may be obtained by the analyzing unit 1410.

Here, the target block is a block that is currently being entropy decoded, and the prediction may be performed in an image format indicated by image format information input together with the calculated-CBP value of the target block.

The operating principle of the estimated CBP value calculating unit 1420 and the actual CBP value calculating unit 1430 are the same as the operating principle of the estimated CBP value calculating unit 520 and the calculated-CBP value calculating unit 530 described above. The following is a detailed description of the operating principle of the estimated CBP value calculating unit 1420 and the actual CBP value calculating unit 1430.

A comparator 1412 of the estimated CBP value calculating unit 1420 compares a CBP value of an block above the target block and a CBP value of a block to the left of the block above the target block.

A predictor 1414 responds to the comparison results of the comparator 1412 and outputs the CBP value of the block to the left of the target block or the CBP value of the block above the target block as a estimated CBP value of the target block.

In more detail, if the comparator 1412 concludes that the CBP value of the block above the target block and the CBP value of the block to the left of the block above the target block are the same, the predictor 1414 determines the CBP value of the block to the left of the target block to be the estimated CBP value of the target block.

Conversely, if the comparator 1412 concludes that the CBP value of the block above the target block and the CBP value of the block to the left of the block above the target block are different, the predictor 1414 determines the CBP value of the block above the target block to be the estimated CBP value.

The actual CBP value calculating unit 1430 performs an XOR operation on the estimated CBP value of the target block and the input calculated-CBP value of the target block to calculate an actual CBP value of the target block.

The actual CBP value calculating unit 1430 may include a first actual CBP value calculator (not shown) and a second actual CBP value calculator (not shown). The first actual CBP value calculator calculates an actual CBP value of a first target block and outputs the calculated result as a first actual CBP value of the first target block. The second actual CBP value calculator calculates an actual CBP value of a second target block using an actual CBP value of a first target block having the same phase as a phase of the second target block and an input calculated-CBP value of the second target block, and outputs the calculated result as a second actual CBP value of the second target block.

The first target block may be a block of a luma component or a block of a chroma component, the second target block may be a block of a chroma component or a block of a luma component, and the image format may be 4:4:4.

The phase of the first target block indicates a relative location of the first target block in a frame including the first target block. The phase of the second target block indicates a relative location of the second target block in a frame including the second target block.

The second actual CBP value calculator can perform an XOR operation on an actual CBP value of the first target block having the same phase as the phase of the second target block and the calculated-CBP value of the second target block. Then, the second actual CBP value calculator outputs the XOR operation result as the second actual CBP value of the second target block.

The CBPCY generating unit 1440 generates a bitstream having the actual CBP value of the target block calculated by the actual CBP value calculating unit 1430 as a CBPCY.

FIG. 15 is a flow chart illustrating an entropy decoding method according to an embodiment of the present invention. The method includes estimating a CBP value of a target block and calculating an actual CBP value of the target block using the estimated CBP value of the target block and a calculated-CBP value of the target block (operations 1510 and 1520), and generating a CBPCY (operation 1530).

The estimated CBP value calculating unit 1420 calculates a estimated CBP value of a target block using CBP values of adjacent blocks (operation 1510). The actual CBP value calculating unit 1430 calculates an actual CBP value of the target block using a given calculated-CBP value of the target block and the calculated estimated CBP value of the target block (operation 1520). After operation 1520, the CBPCY generating unit 1540 generates a CBPCY, which is a bitstream having the actual CBP value (operation 1530).

As described above, the entropy encoding and decoding apparatuses and the entropy encoding and decoding methods can be used to predict a CBP value of a target block using CBP values of adjacent blocks, calculate a calculated-CBP value using the estimated CBP value of the target block and an actual CBP value of the target block, entropy encode the calculated results, and generate an actual CBP value of the target block using the estimated CBP value of the target block and the input calculated-CBP value of the target block. As a result, high quality image data can be efficiently compressed.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image decoding method comprising the operations of:
(a) estimating a CBP (coded block pattern) of a target block using a CBP of at least one block neighboring with the target block; and
(b) calculating a actual CBP of the target block using a calculated-CBP of the target block and the estimated CBP of the target block.

2. The image decoding method of claim 1, wherein operation (a) comprises:
(a1) determining whether a CBP of a block on the upper side of the target block is identical with a CBP of a block on the upper left side of the target block; and
(a2) determining a CBP of a block on the left side of the target block as the estimated CBP of the target block if it is determined in operation (a1) that the CBP of the block on the upper side of the target block is identical with the CBP of the block on the upper left side of the target block.

3. The image decoding method of claim 2, wherein operation (a) further comprises (a3) determining the CBP of the block on the upper side of the target block as the estimated CBP of the target block if it is determined in operation (a1) that the CBP of the block on the upper side of the target block is not identical with the CBP of the block on the upper left side of the target block.

4. The image decoding method of claim 1, wherein operation (b) comprises calculating the actual CBP of the target block by performing XOR on the given calculated-CBP of the target block and the estimated CBP of the target block.

5. An image decoding method comprising the operations of:
(a) estimating a CBP of a block of a luma component using a CBP of at least one block neighboring with the block of the luma component;
(b) calculating a actual CBP of the block of the luma component using a given calculated-CBP of the block of the luma component and the estimated CBP of the block of the luma component; and
(c) calculating a actual CBP of a block of a chroma component having the same phase as a phase of the block of the luma component by using the actual CBP of the block of the luma component and a given calculated-CBP of the block of the chroma component.

6. The image decoding method of claim 5, wherein:
operation (b) comprises calculating the actual CBP of the block of the luma component by performing XOR on the given calculated-CBP and estimated CBP of the block of the luma component; and
operation (c) comprises calculating the actual CBP of the block of the chroma component by performing XOR on the actual CBP of the block of the luma component and the given calculated-CBP of the block of the chroma component.

7. The image decoding method of claim 5, wherein the format of each of the block of the luma component and the block of the chroma component is a 4:4:4 format.

8. An image encoding method comprising the operations of:
(a) estimating a CBP of a target block using a CBP of at least one block neighboring with the target block;
(b) calculating a calculated-CBP of the target block using a actual CBP of the target block and the estimated CBP of the target block; and
(c) encoding the calculated calculated-CBP of the target block.

9. The image encoding method of claim 8, wherein operation (a) comprises:
(a1) determining whether a CBP of a block on the upper side of the target block is identical with a CBP of a block on the upper left side of the target block; and
(a2) determining a CBP of a block on the left side of the target block as the estimated CBP of the target block if it is determined in operation (a1) that the CBP of the block on the upper side of the target block is identical with the CBP of the block on the upper left side of the target block.

10. The image encoding method of claim 9, wherein operation (a) further comprises (a3) determining the CBP of the block on the upper side of the target block as the estimated CBP of the target block if it is determined in operation (a1) that the CBP of the block on the upper side of the target block is not identical with the CBP of the block on the upper left side of the target block.

11. The image encoding method of claim 8, wherein operation (b) comprises calculating the calculated-CBP of the target block by performing XOR on the actual CBP of the target block and the estimated CBP of the target block.

12. An image encoding method comprising the operations of:
(a) estimating a CBP of a block of a luma component using a CBP of at least one block neighboring with the block of the luma component;
(b) calculating a calculated-CBP of the block of the luma component using a actual CBP of the block of the luma component and the estimated CBP of the block of the luma component;
(c) calculating a calculated-CBP of a block of a chroma component having the same phase as a phase of the block of the luma component by using the actual CBP of the block of the luma component and a actual CBP of the block of the chroma component; and
(d) encoding the calculated-CBP of the block of the luma component and the calculated-CBP of the block of the chroma component.

13. An image decoding apparatus comprising:
an estimation unit estimating a CBP of a target block using a CBP of at least one block neighboring with the target block; and
a calculation unit calculating a actual CBP of the target block using a given calculated-CBP of the target block and the estimated CBP of the target block.

14. The image decoding apparatus of claim 13, wherein the estimation unit comprises:
a comparing unit determining whether a CBP of a block on the upper side of the target block is identical with a CBP of a block on the upper left side of the target block; and
an estimated CSP outputting unit outputting a CBP of a block on the left side of the target block as the estimated CBP of the target block in response to the result of the determination.

15. The image decoding apparatus of claim 13, wherein the calculation unit calculats the actual CBP of the target block by performing XOR on the given calculated-CBP of the target block and the estimated CBP of the target block.

16. An image decoding apparatus comprising:
an estimation unit estimating a CBP of a block of a luma component using a CBP of at least one block neighboring with the block of the luma component;
a first pattern calculation unit calculating a actual CBP of the block of the luma component using a given calculated-CBP of the block of the luma component and the estimated CBP of the block of the luma component; and
a second pattern calculation unit calculating a actual CBP of a block of a chroma component having the same phase as a phase of the block of the luma component by using the actual CBP of the block of the luma component and a given calculated-CBP of the block of the chroma component.

17. The image decoding apparatus of claim 16, wherein:
the first pattern calculation unit calculates the actual CBP of the block of the luma component by performing XOR on the given calculated-CBP and estimated CBP of the block of the luma component; and
the second pattern calculation unit calculates the actual CBP of the block of the chroma component by performing XOR on the actual CBP of the block of the luma component and the given calculated-CBP of the block of the chroma component.

18. The image decoding apparatus of claim 16, wherein the format of each of the block of the luma component and the block of the chroma component is a 4:4:4 format.

19. An image encoding apparatus comprising:
an estimation unit estimating a CBP of a target block using a CBP of at least one block neighboring with the target block;
a calculation unit calculating a calculated-CBP of the target block using a actual CBP of the target block and the estimated CBP of the target block; and
a pattern encoding unit encoding the calculated calculated-CBP of the target block.

20. The image encoding apparatus of claim 19, wherein the estimation unit comprises:
a comparing unit determining whether a CBP of a block on the upper side of the target block is identical with a CBP of a block on the upper left side of the target block; and
an estimated CSP outputting unit outputting a CBP of a block on the left side of the target block as the estimated CBP of the target block in response to the result of the determination made by the comparing unit.

21. The image encoding apparatus of claim 19, wherein the calculation unit calculates the calculated-CBP of the target block by performing XOR on the actual CBP of the target block and the estimated CBP of the target block.

22. An image encoding apparatus comprising:
an estimation unit estimating a CBP of a block of a luma component using a CBP of at least one block neighboring with the block of the luma component;
a first pattern calculation unit calculating a calculated-CBP of the block of the luma component using a actual CBP of the block of the luma component and the estimated CBP of the block of the luma component;
a second pattern calculation unit calculating a calculated-CBP of a block of a chroma component having the same phase as a phase of the block of the luma component by using the actual CBP of the block of the luma component and a actual CBP of the block of the chroma component; and
a pattern encoding unit encoding the calculated-CBP of the block of the luma component and the calculated-CBP of the block of the chroma component.
